(19) United States
(12) Patent Application Publication
(10) Pub. No.: US 2014/0218949 A1
(43) Pub. Date: Aug. 7, 2014

(54) AUTOMOBILE LAMP HAVING INTERLOCKING LIGHTING UNITS

(71) Applicant: Chuan-Hsi Chiang, Kaohsiung (TW)

(72) Inventor: Chuan-Hsi Chiang, Kaohsiung (TW)

(21) Appl. No.: 13/757,802

(22) Filed: Feb. 3, 2013

(51) Int. Cl. B60Q 1/00; F21V 15/01

(52) U.S. Cl. CPC B60Q 1/00; F21V 15/012
USPC 362/487

(57) ABSTRACT

An automobile lamp including interlocking lighting units each provided with an outer housing including separate sections each including a lengthwise, intermediate coupling member having inner and outer ridges; a flexible inner housing including a main part and a hollow, minor part, each of the main and minor parts including lengthwise, equally spaced cut-out spaces formed on an outer surface; a base including lengthwise, equally spaced cut-out spaces formed on an outer surface, and a light source disposed on an inner surface wherein the base is sandwiched by the main part and the minor part, the base and the inner housing are disposed in the outer housing with the main part adjustably projecting out of the outer housing, and the inner ridges are fitted into the corresponding out-out spaces to fasten the outer housing, the inner housing, and the base together; and a cover disposed on the inner housing.

### BACKGROUND OF THE INVENTION

1. Field of the Invention

The invention relates to automobile lighting and more particularly to a plurality of lighting units which can be interlocked to form an automobile lamp.

2. Description of Related Art

Conventionally, an automobile lamp (e.g., headlight) is a unitary member threadedly secured to one of four corners of the automobile body. However, it has a disadvantage of being inconveniently removed and even time consuming for replacement if it is broken.

Further, there is no way of adjusting light emitted by the light since it has only one light source.

Thus, the need for improvement still exists.

### SUMMARY OF THE INVENTION

It is therefore one object of the invention to provide a lamp including a plurality of lighting units for an automobile, each lighting unit comprising an outer housing comprising a plurality of separate sections each including a lengthwise, intermediate coupling member having an inner ridge and an outer ridge; a flexible inner housing comprising a main part and a hollow, minor part, each of the main and minor parts including a plurality of lengthwise, equally spaced first cut-out spaces formed on an outer surface; a base comprising a plurality of lengthwise, equally spaced second cut-out spaces formed on an outer surface, and a light source disposed on an inner surface wherein the base is sandwiched by the main part and the minor part, the base and the inner housing are disposed in the outer housing with the main part adjustably projecting out of the outer housing, and the inner ridges are fitted into the corresponding first and second cut-out spaces to fasten the outer housing, the inner housing, and the base together; and a cover shaped to complimentarily, lockingly dispose on the inner housing distal the base.

The above and other objects, features and advantages of the invention will become apparent from the following detailed description taken with the accompanying drawings.

### BRIEF DESCRIPTION OF THE DRAWINGS

FIG. 1 is an exploded view of a lighting unit of an automobile lamp according to a first preferred embodiment of the invention;

FIG. 2 is a perspective view of the assembled lighting unit;

FIG. 3 is a longitudinal sectional view of the lighting unit of FIG. 2;

FIG. 4 is a perspective view of a plurality of the lighting units assembled as a light of an automobile;

FIG. 5 is a perspective view of an automobile having two headlights each including a plurality of the interlocked lighting units;

FIG. 6 is schematic cross-sectional view of four interlocked lighting units of a light of an automobile according to a second preferred embodiment of the invention; and

FIG. 7 is schematic cross-sectional view of three interlocked lighting units of a light of an automobile according to a third preferred embodiment of the invention.

### DETAILED DESCRIPTION OF THE INVENTION

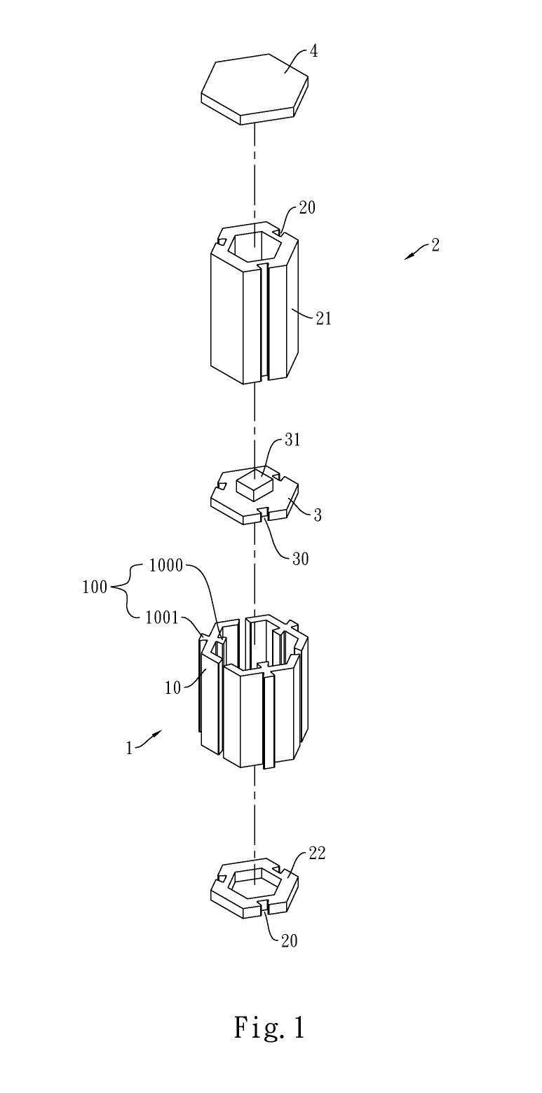

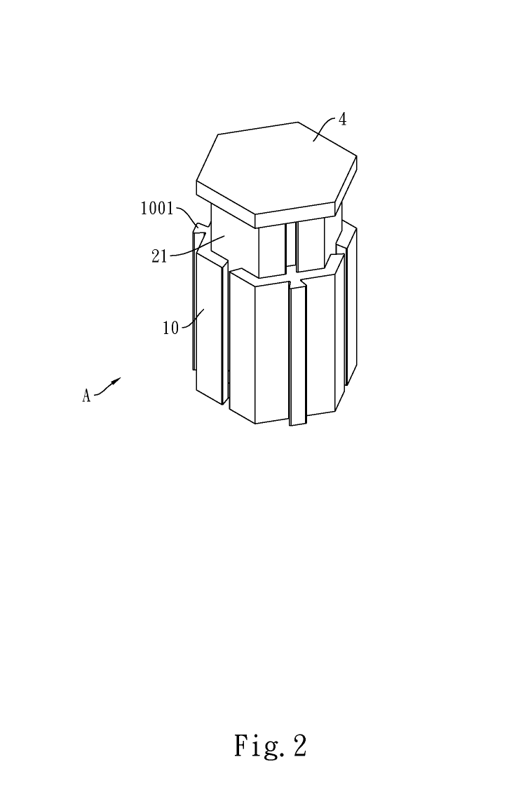

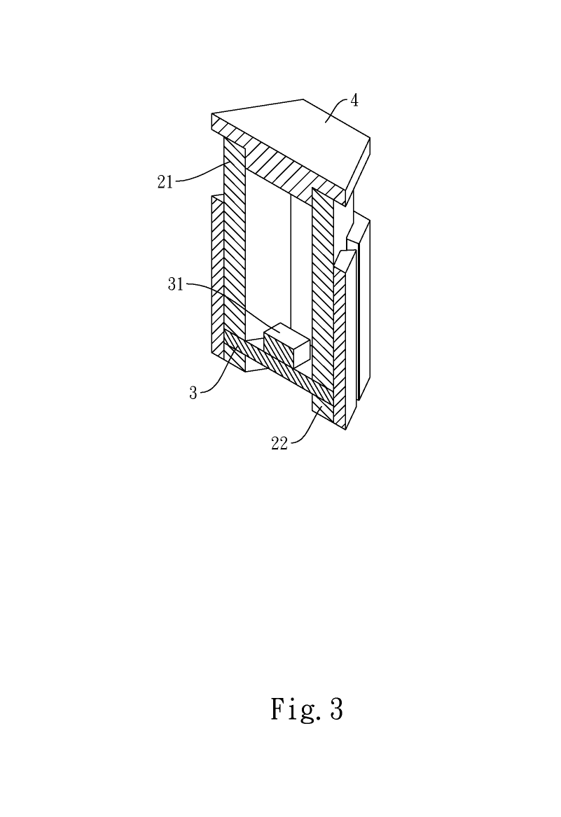

Referring to FIGS. 1 to 5, an automobile lamp (e.g., headlight) in accordance with the invention comprises a plurality of lighting units A each including the following components as discussed in detail below.

An outer housing 1 comprises three separate sections 10 which are preferably made of metal. The section 10 comprises a coupling member 100 along lengthwise, intermediate portion. The coupling member 100 comprises an inner ridge 1000 and an outer ridge 1001. Preferably, each of the inner and outer ridges 1000, 1001 has a cross-section of dove tail.

An inner housing 2 comprises a main part 21 having a hexagonal cross-section and a hollow, minor part 22 shaped as a hexagon. Each of the main and minor parts 21, 22 has three lengthwise, equally spaced cut-out spaces 20 formed on an outer surface. Preferably, the inner housing 2 is made of a flexible material.

A base 3 is shaped as hexagon and comprises three lengthwise, equally spaced cut-out spaces 30 formed on an outer surface, and a light source 31 on an inner surface. The light source 31 is formed of a light-emitting diode (LED). The base 3 is sandwiched by the main part 21 and the minor part 22. The base 3 and the inner housing 2 are disposed in the outer housing 1 with the underside of the minor part 22 being flush with a bottom of the outer housing 1 and a portion of the main part 21 projecting out of an opening of the outer housing 1 distal the base 3. Further, the inner ridges 1000 are fitted into the corresponding cut-out spaces 20 and 30 to fasten the outer housing 1, the inner housing 2, and the base 3 together.

A cover 4 is shaped as a hexagon and has an inner surface shaped to complimentarily, lockingly dispose in the opening of the inner housing 2 distal the base 3 to assemble the automobile lamping unit A. Preferably, the cover 4 is made of transparent material.

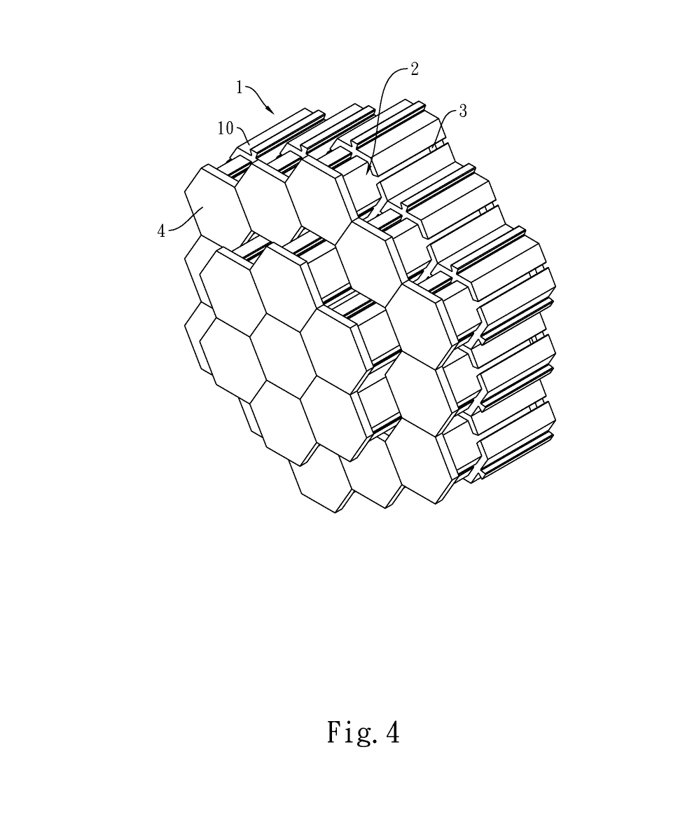

A plurality of the automobile lamping units A as desired can be joined to form an automobile lamp as shown in FIG. 4. The finished automobile lamp has one of different shapes.

Preferably, the portion of the main part 21 projecting out of the opening of the outer housing 1 distal the base 3 can be adjusted as desired in order to adjust a distance between the cover 4 and the light source 31. This has the benefit of emitting light rays of different visual effects.

Preferably, light can pass gaps between any two adjacent sections 10 so as to bring about a special lighting effect.

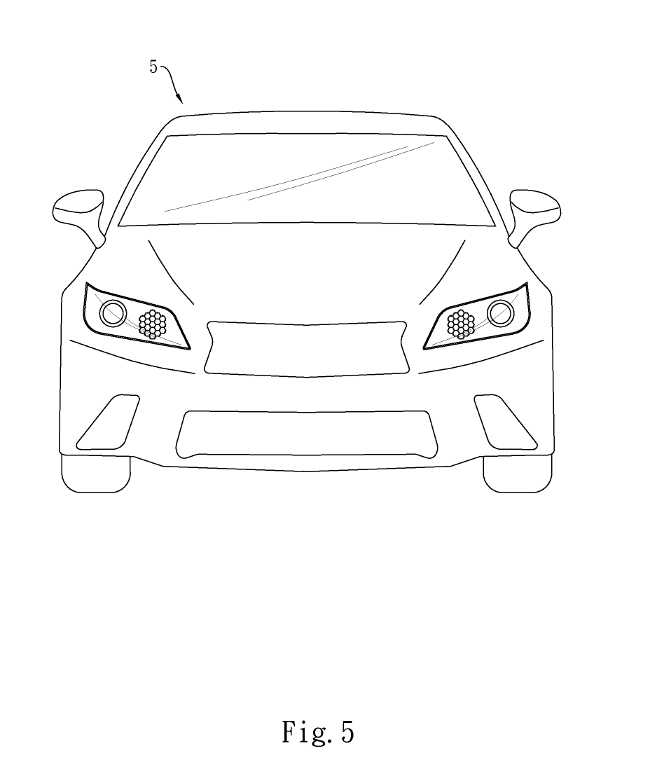

As shown in FIG. 5, the automobile lamp comprised of a desired number of interlocked lighting units A is implemented as a headlight of an automobile 5. Further, an individual can replace any broken lighting units A with new ones in a convenient, economical manner.

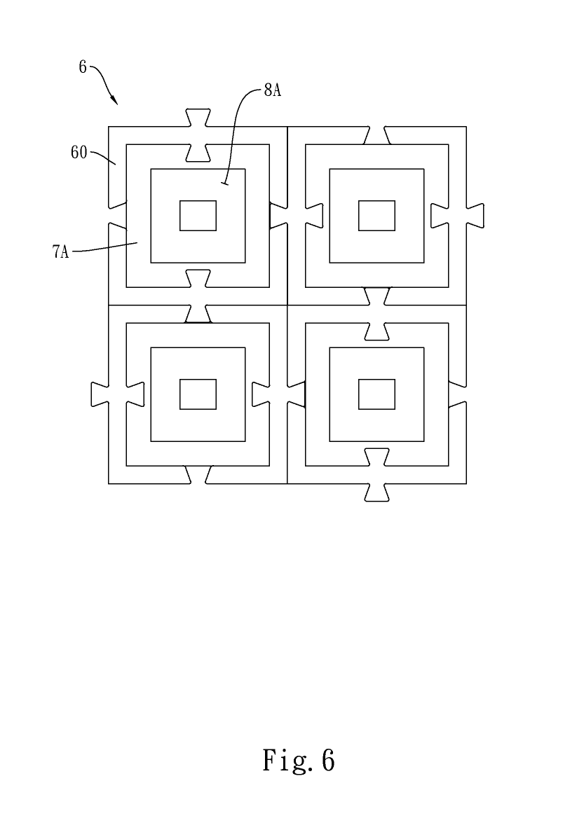

Referring to FIG. 6, an automobile lamp having interlocking lighting units in accordance with a second preferred embodiment of the invention is shown. The characteristics of the second preferred embodiment are substantially the same as that of the first preferred embodiment except the following:

An outer housing 6 comprises two separate sections 60 each having a cross-section of inverted U. An inner housing 7A has a cross-section of square is provided accordingly. Further, a rectangular base 8A is provided accordingly. As shown, an automobile lamp having a cross-section is formed.

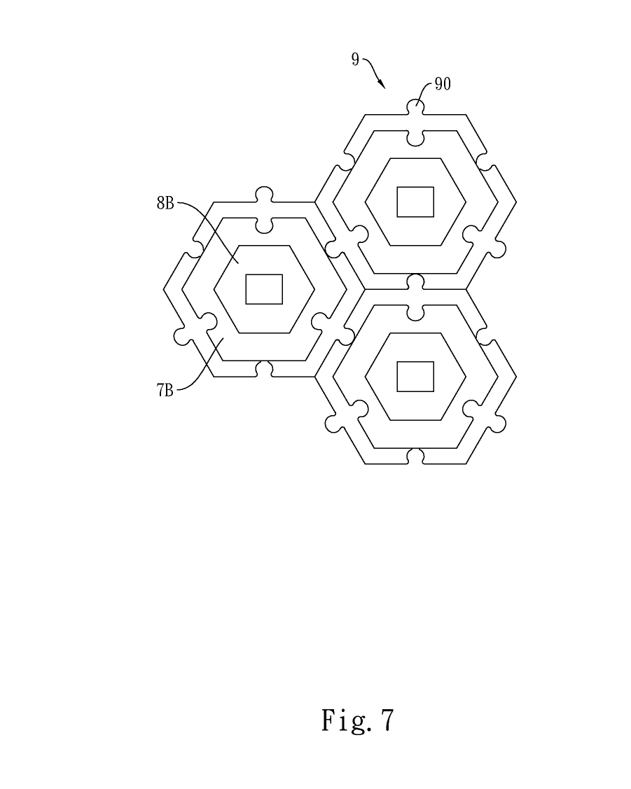

Referring to FIG. 7, an automobile lamp having interlocking lighting units in accordance with a third preferred embodiment of the invention is shown. The characteristics of the third preferred embodiment are substantially the same as that of the first preferred embodiment except the following:

Each of inner and outer ridges of a coupling member 90 of an outer housing 9 has a cross-section of water drop. An inner housing 7B is shaped to complimentarily fit into and lockingly secured to the outer housing 9. Further, a hexagonal base 8B is shaped to complimentarily fit into and lockingly secured to the inner housing 7B.

While the invention has been described in terms of preferred embodiments, those skilled in the art will recognize that the invention can be practiced with modifications within the spirit and scope of the appended claims.

What is claimed is:

1. A lamp including a plurality of lighting units for an automobile, each lighting unit comprising:
an outer housing comprising a plurality of separate sections each including a lengthwise, intermediate coupling member having an inner ridge and an outer ridge;
a flexible inner housing comprising a main part and a hollow, minor part, each of the main and minor parts including a plurality of lengthwise, equally spaced first cut-out spaces formed on an outer surface;
a base comprising a plurality of lengthwise, equally spaced second cut-out spaces formed on an outer surface, and a light source disposed on an inner surface wherein the base is sandwiched by the main part and the minor part, the base and the inner housing are disposed in the outer housing with the main part adjustably projecting out of the outer housing, and the inner ridges are fitted into the corresponding first and second cut-out spaces to fasten the outer housing, the inner housing, and the base together; and
a cover shaped to complimentarily, lockingly dispose on the inner housing distal the base.

2. The lamp of claim 1, wherein the light source is formed of a light-emitting diode (LED).

3. The lamp of claim 1, wherein the cover is transparent.
